(19) United States
(12) Patent Application Publication
(10) Pub. No.: US 2011/0127053 A1
(43) Pub. Date: Jun. 2, 2011

(54) SPADE

(76) Inventor: Adriaan Johannes STOFFELEN, Lundtoft Aabenraa (DK)

(21) Appl. No.: 12/960,957

(22) Filed: Dec. 6, 2010

Related U.S. Application Data
(63) Continuation of application No. PCT/EP2009/056810, filed on Jun. 3, 2009.

(30) Foreign Application Priority Data
Jun. 4, 2008 (NL) 1035539

(51) Int. Cl. A01B 1/02; A01B 1/16

(52) U.S. Cl. 172/381

(57) ABSTRACT

The invention relates to a spade with an additional cutting part resembling a shark fin that is located on the blade with an angle of 90 degrees and of which the front side is about 45 degrees, which makes it possible by means of a T-form incision to remove a taraxacum in its entirety by hand and to push back lumps of earth by the foot, wherein the damage to the lawn is minimal.

### CROSS-REFERENCE TO RELATED APPLICATIONS

This application is a continuation of PCT application Ser. No. PCT/EP2009/056810, filed Jun. 3, 2009, to which priority is claimed, and which claims the benefit of NL 1035539 filed Jun. 4, 2008, to which priority is also claimed.

### BACKGROUND OF THE INVENTION

1. Field of the Invention

The invention relates to a spade.

2. Background Art

The taraxacum, also known as dandelion, has long and deep roots that do not always grow straight downward, which makes it almost impossible to remove the root in its entirety without seriously damaging the lawn, using existing gardening tools.

When using a traditional spade according to the state of the art to remove the taraxacum from the lawn, the normal spade is inserted normally in the ground. When pushing it down towards the body of the person using the spade, the spade will lift a lump of earth with grass and the taraxacum included. However, the deeper part of the root will be separated from the deeper part of the soil. This means that the spade according to the state of the art presses the taraxacum with the entire root upwards, with the surrounding grass and earth upwards. In this way, it is not possible to remove the taraxacum with its entire root by hand, even though the entire root has been lifted from the deeper parts of the soil.

### SUMMARY OF THE INVENTION

By adding to the spade a fin perpendicular to the blade of the spade, the front side of the fin having an angle β of about 45 degrees to the blade of the spade, the spade will make not one, but two incisions. These incisions have an angle of 90 degrees between them, resembling the letter “T”, where the bottom of the letter “T” is directed towards the taraxacum.

### BRIEF DESCRIPTION OF THE DRAWINGS

FIG. 1 shows a front view of the sharkspade 100.

FIG. 2 shows a side view of the sharkspade.

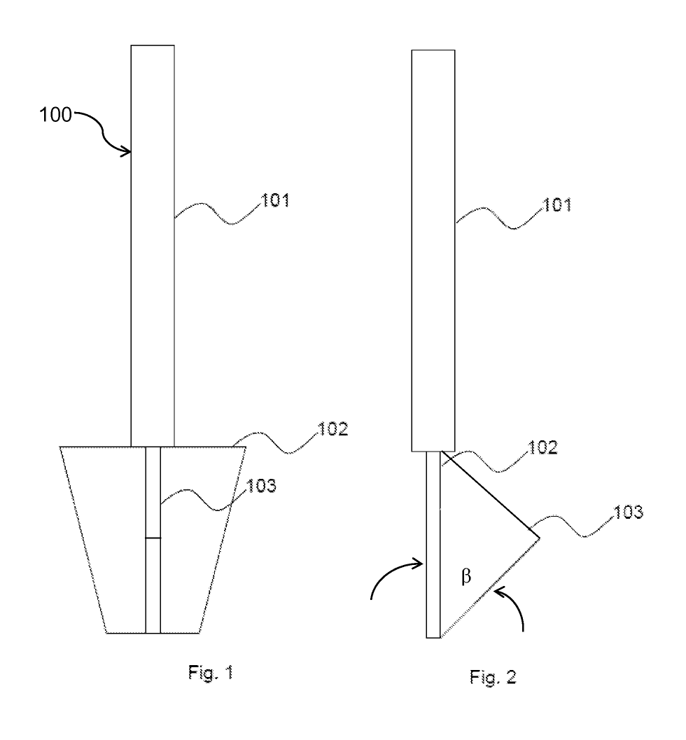

### DETAILED DESCRIPTION OF THE PREFERRED EMBODIMENT(S)

The sharkspade 100 comprises a shaft 101, a blade 102 and a fin 103. With the Sharkspade a T-form incision is made in the lawn which is directed towards the taraxacum with the bottom of the letter “T” pointing at the taraxacum and hence, not one lump of earth will be pushed upward but two half lumps that move little apart at the location where the fin has made the incision. Because the spade also frees the lower part of the root in the deeper part of the soil, it is possible to remove the taraxacum with the hand after which the two lumps of earth can be pushed back, for which reason only two barely visible incisions remain and the damage to the lawn is minimal. The fin should be placed close to the root. Because the incision of the fin is directed at the taraxacum, the earth will move apart creating a small opening in the lawn close to the root of the taraxacum. The sharkspade will have lifted the entire root from the deeper part of the soil. The exposed and lifted taraxacum, including its root, can subsequently be easily removed by the hand. Thus, the sharkspade facilitates manual removal of the entire taraxacum, including the root. Removing the entire root is important as not removing the whole root means that the taraxacum will come back.

In summary, the invention relates to a spade with a shark fin resembling cutting part that is located at an angle of 90 degrees on the spade and of which the front side is about 45 degrees which makes it possible to remove the taraxacum from the ground without damaging the lawn. It will be apparent to a person skilled in the art that the sharkspade can not only be used to remove taraxacums, but also other plants having roots with characteristics similar to those of the root of the taraxacum, being among others that the root grows relatively deep and not necessarily straight down.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. Spade comprising a shaft and a blade with an additional cutting part resembling a shark fin, where the additional cutting part is placed at an angle of 90 degrees on the blade and where a front side of the additional cutting part has an angle of about 45 degrees in relation to the blade which makes it possible by means of a T-form incision in a lawn to remove a plant in its entirety by hand and push back lump of earth by the foot wherein damage to the lawn is minimal, wherein
the front side of the additional cutting part is straight, and
the front side of the additional cutting part connects to the blade at an end of the blade for engaging soil.

2. Spade according to claim 1, wherein the plant is taraxacum.

3. Spade according to claim 1, wherein the part of the blade for engaging soil is straight.
